(19) United States
(12) Patent Application Publication
(10) Pub. No.: US 2014/0370837 A1
(43) Pub. Date: Dec. 18, 2014

(54) System for Initiating an Emergency Communication Using a Wireless Peripheral of a Mobile Computing Device

(71) Applicant: SECURE COURTURE, LLC, Weston, FL (US)

(72) Inventor: Alexander Gladstone, Weston, FL (US)

(21) Appl. No.: 14/373,445

(22) PCT Filed: Jan. 21, 2013
(86) PCT No.: PCT/US2013/022425

§ 371 Date: Jul. 21, 2014

Related U.S. Application Data
(60) Provisional application No. 61/632,446, filed on Jan. 24, 2012.

(51) Int. Cl. H04W 4/22; H04W 8/00

(52) U.S. Cl. CPC H04W 4/22; H04W 8/005
USPC 455/404.1

(57) ABSTRACT

A system for initiating an emergency communication using a commercially available off-the-self (COTS) wireless peripheral of a mobile computing device (10).

Applicant claims priority to PCT Application US2013/022425, filed Jan. 21, 2013, entitled—System for Initiating an Emergency Communication using a Wireless Peripheral of Mobile Computing Device—. Further, Applicant incorporates into the this application, by reference, the simultaneously filed US application entitled—System Utilizing a Combination for Including Information within an Outbound Communication Channel of a Mobile Telephone-Capable Computing Device—claiming priority to PCT Application US2013/022424 filed on Jan. 21, 2013.

### BACKGROUND OF THE INVENTION

### 1. Field of the Invention

Among other things, the present invention includes a system for initiating an emergency communication from a mobile computing device whenever a previously selected commercially available off-the-self (COTS) wireless peripheral becomes available.

### SUMMARY OF THE INVENTION

Unlike prior art systems, the current invention supplies a system enabling a user of a mobile computing device (MCD) to select from a list of one or more commercially available off-the-shelf (COTS) wireless peripherals, and to further cause the mobile computing device to transmit at least one outbound emergency communication whenever the user activates the wireless peripheral within communications range of said MCD.

Select preferred aspects of the current system allow a mobile computing device (MCD) to accomplish one or more of the following:

To store at least one identifier representing at least one COTS wireless peripheral, and to initiate at least one emergency communication with at least one location remote from the MCD in response to a later activation of the COTS wireless peripheral;

To enter into a wireless peripheral discovery process, list discovered peripherals, and accept a user-selection of one or more peripherals;

To list previously trusted wireless peripherals and accept a user-selection of one or more peripherals;

To list available wireless peripherals, accept a user-selection of one or more peripherals, and store device identifiers and/or addresses associated with the selected peripherals;

To match the device identifiers of discovered wireless peripherals to previously stored identifiers, and to transmit, in response to a match, at least one emergency communication to a location remote from the MCD;

To continuously attempt to form communications links with wireless peripherals using a list of device identifiers and addresses, and upon successful formation of at least one such communications link, to transmit at least one emergency communication to a location remote from the MCD;

To initiate the transmission of at least one emergency communication to a location remote from the MCD irrespective of limits imposed on the user's ability to physically interact with the user interface(s) of the MCD at the time of the emergency; and/or

To send one or more emergency communications to multiple locations remote from the MCD via multiple communications channels including an outbound voice-over-ip communications channel of the MCD.

A preferred embodiment of the current invention can be described as a system for initiating an emergency communication; the system comprising one or more commercially available off-the-self (COTS) wireless peripherals capable of forming a communication channel with a mobile computing device; the mobile computing device further comprising: a) a memory capable of storing one or more programs and information about one or more of the COTS wireless peripherals; b) a processor for managing the programs, wherein the programs comprise at least three program codes controlling the system; c) a first program code executable by the processor causing the mobile computing device: i) to enter into a wireless peripheral discovery process, wherein the discovery process comprises creation of a discovery list; and/or ii) to retrieve a trust list of trusted COTS wireless peripherals trusted by the mobile computing device; d) a second program code executable by the processor causing the mobile computing device to present: i) the discovery list of wireless peripherals discovered during said wireless peripheral discovery process to a user and store in the memory at least one of the discovered COTS wireless peripheral identifiers; and/or ii) the trust list of wireless peripherals to the user such that the user can select at least one of the wireless peripherals and its corresponding identifier previously stored in the memory; and e) a third program code executable by the processor causing the mobile computing device to initiate through a wireless network communications link at least one emergency communication to a location remote from the mobile computing device subsequent to: i) performing the wireless peripheral discovery process to discover at least one of the COTS wireless peripheral identifiers matching a corresponding one of the discovery list's wireless peripheral identifiers; or ii) using the COTS peripheral identifiers and peripheral addresses stored in the memory to form the communication channel with one or more of the COTS wireless peripherals; or iii) using the trust list to match at least one available COTS wireless peripheral identifiers with its stored corresponding COTS wireless peripheral identifier.

It is the novel and unique interaction of these simple elements which creates the system within the ambit of the present invention. Pursuant to the Articles of the Patent Cooperation Treaty, select preferred embodiments of the current invention follow. However, it is to be understood that the descriptions of the preferred embodiments do not limit the scope of the present invention.

### BRIEF DESCRIPTION OF THE DRAWINGS

FIG. 1 is an illustration of a preferred embodiment of the current system including COTS wireless peripherals 20, a mobile computing device 10, and a network 99 supporting the mobile computing device.

FIG. 2 is an exemplification of the wireless peripheral device 20 discovery process and the interactions between a user, a wireless peripheral 20, a COTS MCD 10 and a wireless network 99 supporting MCD 10.

FIG. 3 is an illustration of select interactions between a user, a wireless peripheral 20, a mobile computing device 10, and a network 99 supporting the mobile computing device 10 in a preferred embodiment of the system using trusted wireless peripherals 20.

FIGS. 4 A-D are exemplary graphical user interfaces of the mobile computing device 10 that can be associated with a wireless peripheral selection of the current system.

FIG. 5 is a depiction of programmatic actions of the mobile computing device 10 associated with select preferred embodiments of the current system.

FIG. 6 is a diagram depicting destinations capable of receiving an emergency communication of the current system.

### DESCRIPTION OF THE PREFERRED EMBODIMENTS

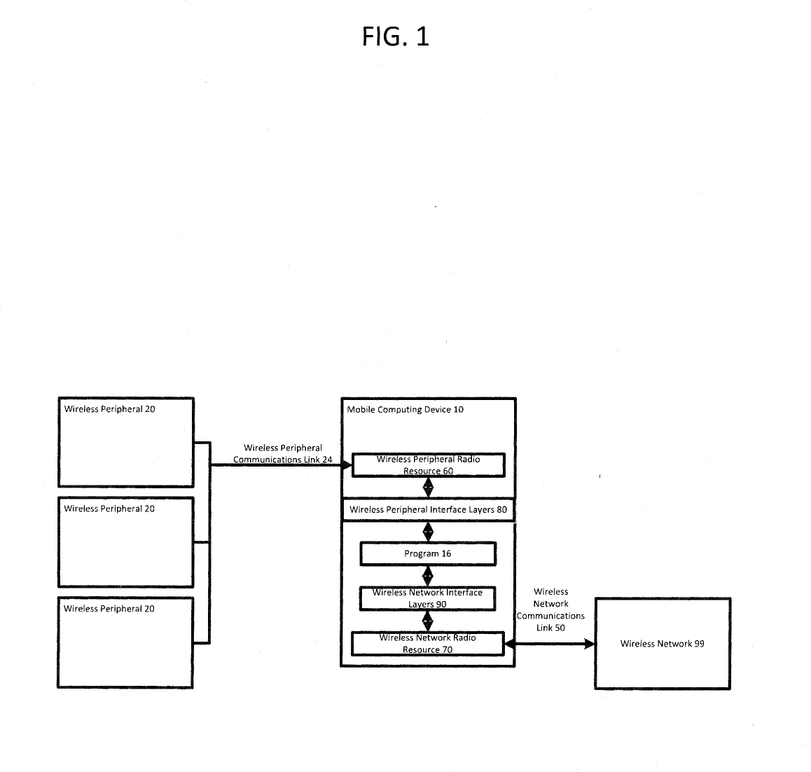

Preferred embodiments of the current system utilize a commercially available off-the-shelf (COTS) mobile computing device (MCD) 10 with one or more COTS wireless peripherals 20. FIG. 1 illustrates a preferred embodiment of a COTS MCD 10 in communication with one or more wireless peripherals 20 and a wireless network 99. For select preferred embodiments, MCDs 10 allow simultaneous communication with multiple wireless peripherals 20 and support multiple communications standards effecting communications, e.g., implementations of Bluetooth™, Near-Field Communications (NFC) standards, and Wi-Fi standards. Within the scope of the current system, any communications system can be supported by wireless peripherals 20 and MCDs 10.

Implementations of COTS wireless peripherals 20 can be discoverable devices compatible with standards and protocols implemented by other devices allowing the other devices to detect or query for the presence of discoverable devices and receive device discovery information including identifiers that uniquely identify the discoverable device. A non-limiting example of such a standard or protocol is the Bluetooth™ Service Discovery Protocol (SDP). Discoverable devices may not be discoverable when switched off. By way of example, some implementations of Bluetooth™ headsets or other devices implementing the Bluetooth™ Hands-Free Profile (HFP) have operating means allowing the user to interact with an off/on interface to control any support of device discovery protocols.

Although FIG. 1 depicts a single wireless network 99, select implementations of COTS MCDs 10 support multiple types of communications systems, either individually or in combination. Preferred embodiments of the current system can effect communications between MCD 10 and locations remote from MCD 10, and can utilize any of the following: terrestrial wireless networks such as WCDMA, GSM, and LTE networks, and satellite-telecommunications networks such as Inmarsat™, Iridium™, and Thuraya™ networks. Within the scope of the current system, when circuit-switched communications are not required for emergency communications or packet data communications are substituted, available local wireless area networks, such as but not limited to Wi-Fi™ networks, are considered to be wireless networks 99 as long as the local wireless network allows for the routing of communications to locations remote from the local wireless network and MCD 10.

As further illustrated in FIG. 1, one or more wireless peripherals 20 can communicate with a COTS MCD 10 over wireless peripheral communications link 24. One or more wireless peripheral radio resources 60 of MCD 10 transmit/receive radio signals from each peripheral 20. Control over wireless peripheral radio resource 60 and wireless network radio resource 70 generally requires in-depth knowledge of the hardware implementing resources (60, 70) and communications protocols between devices and radio resources (60, 70). For these reasons, COTS MCDs 10 can utilize software constructs to hide the implementation details of resources (60, 70) from programs such as program 16 that are executable by processors of MCD 10. The simplifying constructs are shown in FIG. 1 as wireless peripheral interface layers 80 and wireless network interface layers 90.

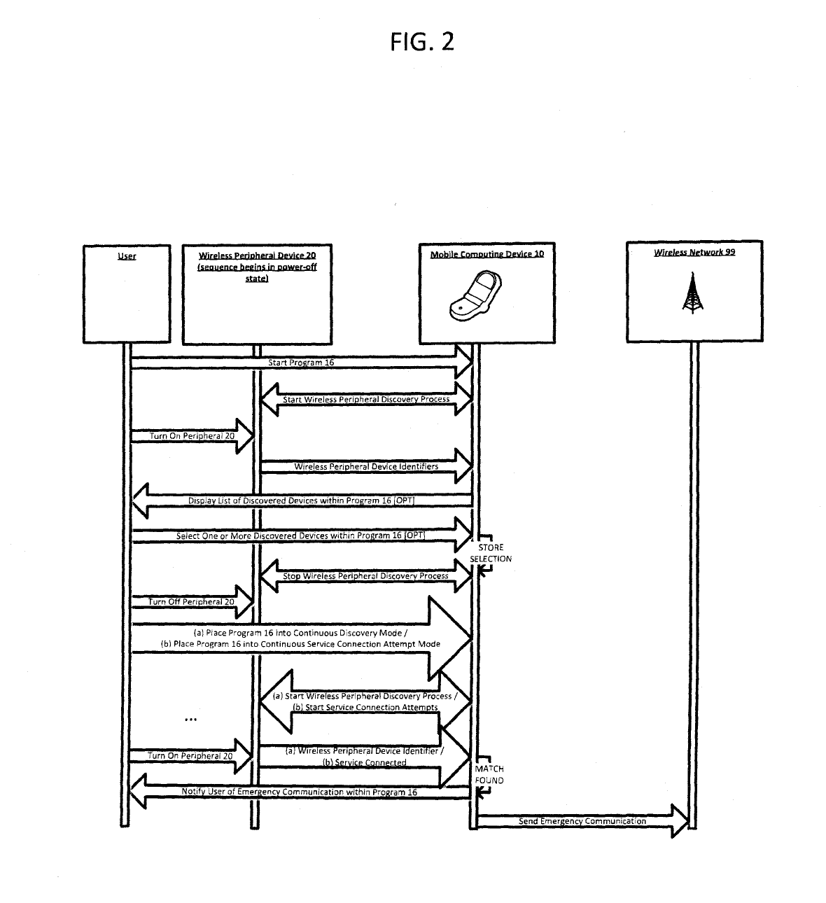

FIG. 2 is an exemplification of the wireless peripheral device 20 discovery process and the interactions between a user, a wireless peripheral 20, a COTS MCD 10 and a wireless network 99 supporting MCD 10. When a user starts at least one of programs 16 of MCD 10, a sequence of actions is initiated and program 16 interacts with wireless peripheral interface layers 80 to commence the wireless peripheral discovery process. When the user turns on a peripheral 20 supporting a wireless peripheral discovery process protocol, e.g., Bluetooth™ Service Discovery Protocol, and an inquiry from MCD 10 is received by peripheral 20, peripheral 20 can transmit discovery information including a peripheral device 20 identifier. After the discovery information is received and processed by the wireless peripheral radio resource 60 and layers 80 of MCD 10, with some preferred embodiments of program 16, the user can review and select from a list of discovered devices. In selected preferred embodiments of the current system, the user can be notified as each peripheral device 20 is discovered and can be given a time-limited or time-unlimited window to cancel or confirm selection of a peripheral device 20. After the selection process is completed, program 16 stores at least a portion of the discovery information for the selected peripheral(s) 20. The stored information can include: device 20 names, unique device addresses, and lists of services made available by each peripheral 20 including service protocols and service port numbers. When the user turns off peripheral 20, program 16 is placed into one or more of the following modes: a continuous discovery mode where program 16 periodically initiates a new wireless peripheral discovery process until a peripheral 20 provides discovery information including an identifier matching one of the stored peripheral device 20 identifiers and/or a continuous service connection attempt mode where program 16 periodically requests a connection be formed between MCD 10 and at least one of the stored available services associated with each of the selected peripherals 20. While program 16 is performing a continuous discovery mode and/or a continuous service connection attempt mode (hereinafter the operational modes), COTS MCD 10 remains operational as engineered by the manufacturer of the COTS MCD 10. When an emergency arises, the user turns on peripheral 20 and, if necessary, brings peripheral 20 within transmission range of MCD 10 such that via one of the modes, program 16 matches an identifier of a discoverable peripheral 20 with a stored identifier and/or connects to an available service available peripheral 20. Thereafter, program 16 utilizes a wireless network transmission means of MCD 10 to send an emergency communication to a location remote from MCD 10 and can notify the user of the sent emergency communication via vibrational, audible and/or graphical alerts associated with MCD 10 and/or signaling other devices in communication with MCD 10.

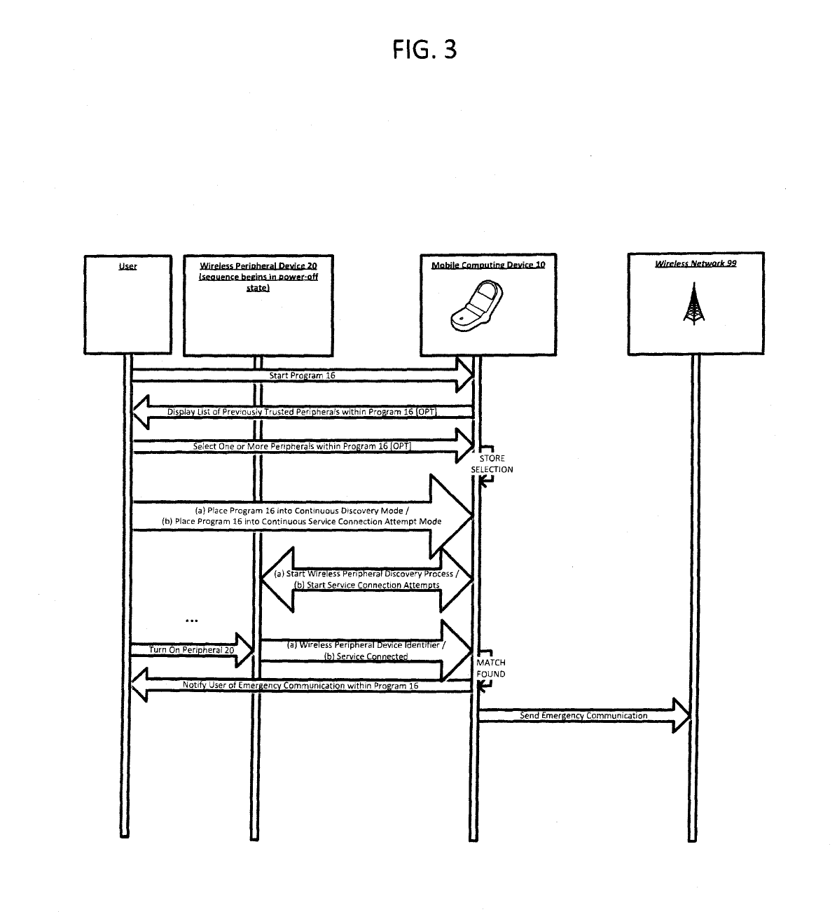

FIG. 3 illustrates a preferred embodiment of the current system utilizing one or more trusted peripherals 20 and the interactions between a user, a wireless peripheral 20, a COTS MCD 10, and a network 99 supporting the mobile computing device. The sequence of FIG. 3 is similar to the sequence of FIG. 2. However, after the start of program 16, program 16 accesses a memory store of MCD 10 and retrieves a set of identifiers in association with peripherals 20 trusted by MCD 10. Non-limiting examples of peripherals 20 and trust processes are Bluetooth™ implementations of wireless peripherals 20 that have undergone a Bluetooth™ pairing process resulting in cryptographic keys being stored in both a memory of MCD 10 and a memory of peripheral 20.

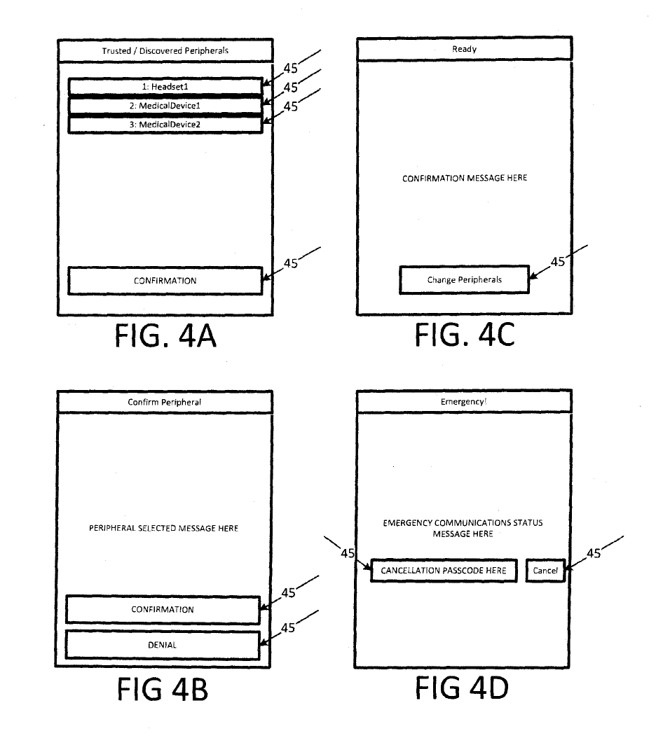

FIG. 4A illustrates select preferred embodiments of graphical user interfaces of MCD 10 for the selection of one or more wireless peripherals 20. For select preferred embodiments of the current system, the user can interface with program 16 of MCD 10 using one or more graphical buttons 45, e.g., confirmation, change peripherals and/or cancellation buttons. Although not shown in FIG. 4A, for other preferred embodiments of the system, any user input modality supported by MCD 10 such as touchscreen input, keypad input, voice recognizer input and/or eye tracking inputs can be used to interface with program 16.

FIG. 4B illustrates an alternative listing to FIG. 4A where program 16 presents the first discovered peripheral device 20 as the functional peripheral device 20 and allows the user to confirm or deny usage of the first discovered peripheral device 20. When the first discovered peripheral device 20 is denied, program 16 presents the next discovered peripheral device 20 to the user for confirmation or denial. After the peripheral device selection processes are completed, program 16 utilizes the operational modes previously enabled and can present to the user a screen, such as FIG. 4C, indicating program 16 is ready to initiate emergency communications. As illustrated in FIG. 4C, if the user desires to change a prior selection of peripheral devices 20, the change peripherals button disables the modes and returns the user to the selection process enabled in FIG. 4A or FIG. 4B.

FIG. 4D illustrates a screen notifying the user whenever the modes are exited and an emergency communication is initiated or cancelled. In select preferred embodiments, MCD 10 screen shows status of the emergency communications process, and gives the user the option to cancel the emergency communications. The user can enter a cancellation passcode or passphrase into a textbox and confirm the entry with a “Cancel” button. Locations remote from MCD 10 receiving the cancellation passcode or passphrase or an indication from program 16 regarding the validity of the cancellation passcode and confirming the cancellation can notify emergency responders of the cancellation.

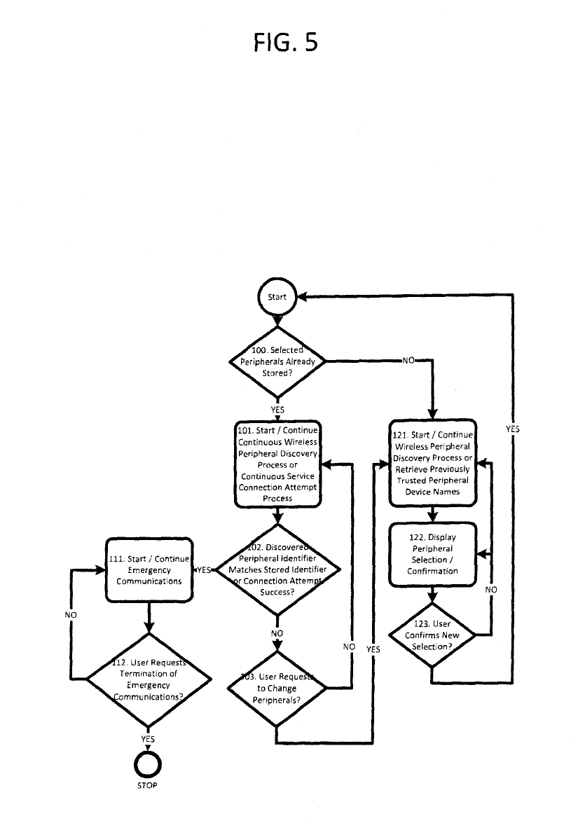

FIG. 5 illustrates diagrams depicting select programmatic actions of MCD 10 and the current system. At step 100, program 16 is started and attempts to retrieve one or more peripheral device 20 identifiers from a memory store of MCD 10. If no peripheral device 20 identifiers are detected, step 121 initiates the peripheral discovery process or trusted peripheral retrieval process. At step 122, a listing of peripheral devices 20 associated with MCD 10 is displayed, and at step 123, the user confirms the selection of a peripheral device 20. After confirmation of a peripheral device 20, program 16 stores the associated peripheral device 20 identifier and, having fulfilled the check of step 100, initiates step 101 and starts the operational modes illustrated in FIG. 2. For select preferred embodiments, a user can update the peripheral device 20 selection. The updating of the device 20 selection process halts the modes—causing program 16 to pass the check of step 103 and reenter step 121. If not halted, program 16 remains at step 101 until a user interaction with one of the selected and stored peripherals causes said peripheral to respond to program 16 satisfying the check at step 102 and initiating step 111. At step 111, emergency communications are sent to one or more locations remote from MCD 10 until the user requests the termination of emergency communications at step 112. When circumstances require, entry of a cancellation passcode or passphrase confirms the cancellation and triggers additional communications signaling that the originally initiated emergency communications are to be ignored as enabled in FIG. 4D.

For select preferred embodiments of the current system, emergency communications can rely entirely on information stored in MCD 10 to determine emergency communications types, content, and the network addresses, phone numbers, or other identifiers used to identify destinations for the emergency communications. For other select preferred embodiments of the current system, emergency communications rely on sensors and/or inputs in communication with COTS MCD 10. Examples of sensors and/or inputs can include: biometric, geographic location, accelerometric or shock, audio inputs, still image and/or video inputs, and network or local device time keeping instruments inputs. Within the scope of the current system, using any of the available wireless network radio resources and the protocols, message types and/or message formats supported by the system's resources, any combination of content can be delivered to any number of locations remote from MCD 10, where the content can be delivered sequentially, randomly, in round-robin or simultaneously.

Within the scope of the current system, along with the COTS MCD 10 processor and memory, one or more programs 16 and information about one or more peripherals 20 are stored are stored in the memory. The COTS MCD 10 processor manages program codes 63. The current system utilizes at least three program codes (63A, 63B, 63C). When first program code 63A is executed by the processor, program code 63A causes MCD 10 to: enter into a wireless peripheral discovery process that creates a discovery list of discovered peripherals (20); and/or retrieves a trust list of trusted COTS wireless peripherals (20) trusted by mobile computing device 10. At the execution of program code 63B by the processor, program code 63B causes MCD 10 to present: the discovery list of wireless peripherals 20 to a user and store in the memory at least one of the discovered COTS wireless peripheral identifiers; and/or the trusted list of wireless peripherals 20 to the user such that the user can select at least one of the wireless peripherals 20 and its corresponding identifier previously stored in the memory. With the execution of program code 63C, program code 63 C causes MCD 10 to initiate through a wireless network communications link 50 at least one emergency communication to a location remote from the mobile computing device subsequent to causing MCD 10 to: perform the wireless peripheral discovery process to discover at least one of the COTS wireless peripheral identifiers matching a corresponding one of the discovery list's wireless peripheral identifiers 20; or use the COTS peripheral identifiers and peripheral addresses stored in the memory to form the communication channel 24 with one or more of the COTS wireless peripherals 20; or use the trusted list to match at least one available COTS wireless peripheral identifiers with its stored corresponding COTS wireless peripheral identifier.

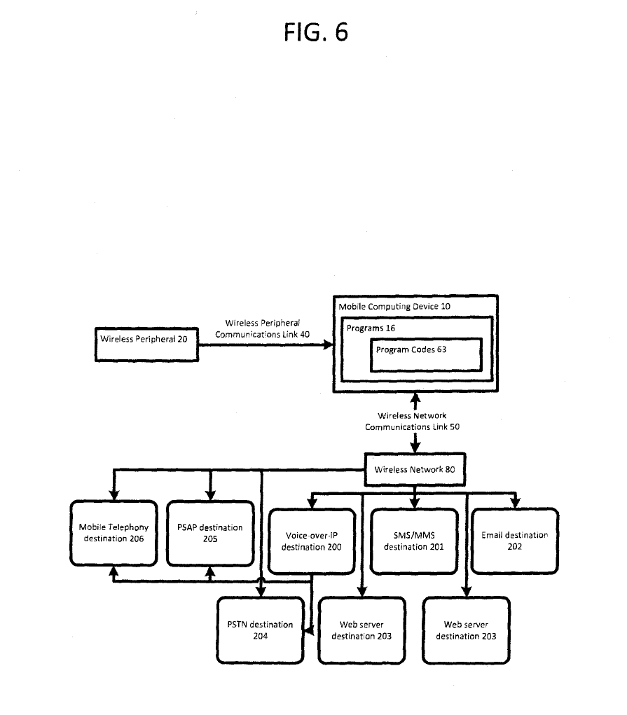

As illustrated in FIG. 6, when wireless peripheral device 20 is turned on, program 16 of MCD 10 enters an emergency communication process and sends an emergency communication to at least one location remote from MCD 10 by sending one or more messages via a wireless network 99. In select preferred embodiments of the current system, the MCD 10 operates at the request of programs such as program 16 to queue up and eventually send emergency communication SMS and MMS messages to SMS/MMS destinations 201. In other preferred embodiments of the current system, MCD 10 at the request of a program 16 sends emergency communications in the form of e-mail messages to internet addressable destinations such as email destination 202. In another preferred embodiment of the current system, MCD 10 sends the emergency notification to internet addressable destinations including one or more webserver destinations 203 where the webservers are instant message servers, social network servers or have connections to instant message servers or social network servers such that instant messages are disseminated to multiple recipients or posts to social networks and/or social network feeds remote from device 10. In another preferred embodiment of the current system, an emergency communication accesses audio hardware of MCD 10 and sends and receives audio to internet addressable Voice-over-IP destinations 200. In another preferred embodiment of the current system, program 16 causes COTS MCD 10 to directly dial and connect to public switched telephone network (PSTN) destinations 204, telephony destinations 206, or public-safety answering point (PSAP) destinations 205. For some COTS MCDs 10, programmatic requests to dial phone numbers and create telephony connections are prohibited or require direct user confirmation using a user-interface of MCD 10. When COTS MCD 10 prohibits or impedes telephony connections, for select preferred embodiments of the current system and without user intervention, destinations 204, 205 and 206 can be contacted by creating an emergency communication channel using voice-over-IP with a implementation of Voice-over-IP destination 200 operable to form calls or even multi-party calls to destinations such as 204, 205, and 206.

Within the scope of the current system, emergency communications contain information useful to emergency responders. Non-limiting examples of information can include one or more of the following: existence of an emergency, geographic location of MCD 10 reporting an emergency, rate of travel of MCD 10 reporting the emergency, accuracy of location or rate of travel information, presumed type of emergency, reported type of emergency, descriptions of the user of MCD 10 involved in the emergency including name, identification, and physical features, data from inputs and sensors in communication with MCD 10, metadata describing the user such as customer IDs capable of identifying some or all of the information describing the user at an internet addressable computer system or database remote from MCD 10.

Pursuant to the Articles of the Patent Cooperation Treaty, preferred embodiments of the current system invention have been disclosed and enabled.

What is claimed is:

1) A system for initiating an emergency communication; said system comprising one or more commercially available off-the-self (COTS) wireless peripherals (20) capable of forming a communication channel (24) with a mobile computing device (10); said mobile computing device (10) further comprising:
a) a memory capable of storing one or more programs (16) and information about one or more of said COTS wireless peripherals (20);
b) a processor for managing said programs (16), wherein said programs (16) comprise at least three program codes (63) controlling said system;
c) a first program code (63A) executable by said processor causing said mobile computing device (10) to:
i) enter into a wireless peripheral (20) discovery process, wherein said discovery process comprises creation of a discovery list; and/or
ii) retrieve a trust list of COTS wireless peripherals (20) trusted by said mobile computing device (10);
d) a second program code (63B) executable by said processor causing said mobile computing device (10) to present:
i) said discovery list of wireless peripherals (20) discovered during said wireless peripheral (20) discovery process to a user and store in said memory at least one of said discovered COTS wireless peripheral (20) identifiers; and/or
ii) said trust list of wireless peripherals (20) to said user such that said user can select at least one of said wireless peripherals (20) and its corresponding identifier previously stored in said memory; and
e) a third program code (63C) executable by said processor causing said mobile computing device (10) to initiate through said wireless network communications link (50) at least one emergency communication to a location remote from said mobile computing device (10) subsequent to:
i) performing said wireless peripheral (20) discovery process to discover at least one of said COTS wireless peripheral (20) identifiers matching a corresponding one of said discovery list's wireless peripheral (20) identifiers; or
ii) using said COTS peripheral identifiers and peripheral addresses stored in said memory to form said communications channel (24) with one or more of said COTS wireless peripherals (20); or
iii) using said trust list to match at least one available COTS wireless peripheral (20) identifiers with its stored corresponding COTS wireless peripheral (20) identifier.

2) The system of claim 1, wherein said COTS MCD (10) generates a notification to said user that said emergency communication was forwarded to said location remote from said COTS MCD (10).

3) The system of claim 2, wherein said user can optionally:
a) cancel a previously initiated emergency communication; or
b) reselect said COTS wireless peripheral (20) and its corresponding identifier previously cancelled to initiate said at least one emergency communication; or
c) select another said COTS wireless peripheral (20) and its corresponding identifier to initiate said at least one emergency communication.

4) The system of claim 3 further comprising biometric, geographic location, accelerometric or shock sensors, audio inputs, still image and/or video inputs, and network or local device time keeping instruments inputs.

5) The system of claim 4, wherein said COTS MCD (10) comprises wireless interface layer (80) capable of communicating with said program (16).

6) The system of any of the previous claims, wherein said COTS MCD (10) comprises:
a) a peripheral radio resource (60); and
b) a wireless network radio resource (70).

7) The system of any of the previous claims, wherein said location remote from said mobile computing device (10) is one or more of the following: SMS/MMS destinations (201), e-mail destinations (202), Voice-over-IP destinations (200), public switched telephone network (PSTN) destinations (204), circuit-switched telephony destinations (206) and/or public-safety answering point (PSAP) destinations (205).

8) The system of any of the previous claims, wherein said network (99) comprises WCDMA, GSM, LTE, Wi-Fi and/or satellite-telecommunications networks.

9) A system for initiating an emergency communication; said system comprising one or more commercially available off-the-self (COTS) wireless peripherals capable of forming a communication channel with a commercially available off-the-self (COTS) mobile computing device; said COTS mobile computing device further comprising:
a) a memory capable of storing one or more programs and information about one or more of said COTS wireless peripherals;
b) a processor for managing said programs, wherein said programs comprise at least three program codes controlling said system;
c) a first program code executable by said processor causing said mobile computing device to:
i) enter into a first wireless peripheral discovery process, wherein said first discovery process comprises creation of a discovery list of discovered COTS wireless peripheral identifiers; and/or
ii) retrieve a trust list of trusted COTS wireless peripherals trusted and previously stored in said memory;
d) a second program code executable by said processor causing said mobile computing device to:
i) reveal said discovery list of wireless peripherals discovered during said first wireless peripheral discovery process such that said user can select and store in said memory any revealed COTS wireless peripheral identifier; and/or
ii) reveal said trust list of wireless peripherals such that said user can select and store in said memory said selection of any revealed COTS wireless peripheral identifier; and
e) a third program code executable by said processor causing said mobile computing device to:
i) perform a second wireless peripheral discovery process to discover at least one of said selected COTS wireless peripherals matching a corresponding one of said selected wireless peripheral identifiers; said second discovery process continuing until at least one of said selected COTS wireless peripherals is discovered; or
ii) perform a service connection process to establish a communication, via said communications channel, with at least one of said selected wireless peripherals matching a corresponding one of said selected wireless peripheral identifiers; said service connection process continuing until a connection is established; and
iii) subsequent to said second discovery process or said service connection process, and in response to said user's interaction with an interface of one of said selected wireless peripherals, said COTS mobile computing device, via network communications link, communicates at least one emergency communication to a location remote from said COTS mobile computing device.

10) The system of claim 9, wherein said COTS mobile computing device comprises:
a) a peripheral radio resource; and
b) a wireless network radio resource.

11) The system of claim 10, wherein said COTS mobile computing device comprises a wireless interface layer (80) capable of communicating with said program.

12) The system of claim 11, wherein said COTS mobile computing device generates a notification to said user that said emergency communication was forwarded to said location remote from said COTS MCD.

13) The system of claim 12, wherein said user can:
a) cancel an initiated emergency communication; or
b) reselect said selected COTS wireless peripheral and its corresponding identifier previously cancelled to initiate said at least one emergency communication; or
c) select another said COTS wireless peripheral to replace said selected COTS wireless peripheral.

14) The system of claim 13 further comprising biometric, geographic location, accelerometric or shock sensors, audio inputs, still image and/or video inputs, and network or local device time keeping instruments inputs.

15) The system of claim 13, wherein said location remote from said mobile computing device is one or more of the following: SMS/MMS destinations, e-mail destinations, Voice-over-IP destinations, public switched telephone network (PSTN) destinations, circuit-switched telephony destinations and/or public-safety answering point (PSAP) destinations.

16) The system of claim 15, wherein said network comprises WCDMA, GSM, LTE, Wi-Fi and/or satellite-telecommunications networks.

17) A system for initiating an emergency communication; said system comprising one or more commercially available off-the-self (COTS) wireless peripherals forming a communication channel with a commercially available off-the-self (COTS) mobile computing device capable of communicating, via a commercial network, an emergency communication to a location remote from said COTS mobile computing device; said COTS mobile computing device further comprising: one or more programs and information about one or more of said COTS wireless peripherals stored in a memory and a processor managing and executing said programs, wherein said programs comprise at least three program codes controlling said system: said program codes comprising:
a) a first program code causing said mobile computing device to retrieve a discovery list of discovered COTS wireless peripheral identifiers discovered and previously stored in said memory or retrieve a trust list of trusted COTS wireless peripherals trusted and previously stored in said memory;
b) a second program code causing said mobile computing device to:
i) reveal said discovery list of wireless peripherals, thereby allowing any revealed COTS wireless peripheral identifier to be stored in said memory; and/or
ii) reveal said trust list of wireless peripherals, thereby allowing any revealed COTS wireless peripheral identifier to be stored in said memory; and
c) a third program code causing said mobile computing device to:
i) discover and match at least one of said selected COTS wireless peripherals with a corresponding wireless peripheral identifier; or
ii) establish a communication, via said communications channel, with at least one of said selected COTS wireless peripherals; and
iii) subsequent to said discover and match of said selected COTS wireless peripherals with said corresponding wireless peripheral identifier or establishment of said communications channel with said selected COTS wireless peripherals, in response to a user's interaction with an interface of said discovered and matched wireless peripheral or with an interface of said wireless peripheral with communications established, said COTS mobile computing device, via network communications link, communicates said emergency communication.

18) The system of claim 17, wherein said COTS mobile computing device comprises:
a) a peripheral radio resource; and
b) a wireless network radio resource.

19) The system of claim 18, wherein said COTS mobile computing device comprises a wireless interface layer capable of communicating with said program.

20) The system of claim 19, wherein said user can:
a) cancel said emergency communication; or
b) reselect said selected COTS wireless peripheral and its corresponding identifier; or
c) select another said COTS wireless peripheral to replace said selected COTS wireless peripheral.

21) The system of claim 20 further comprising biometric, geographic location, accelerometric or shock sensors, audio inputs, still image and/or video inputs, and network or local device time keeping instruments inputs.

22) The system of claim 20, wherein said location remote from said mobile computing device is one or more of the following: SMS/MMS destinations, e-mail destinations, Voice-over-IP destinations, public switched telephone network (PSTN) destinations, circuit-switched telephony destinations and/or public-safety answering point (PSAP) destinations.

23) The system of claim 22, wherein said network comprises WCDMA, GSM, LTE, Wi-Fi and/or satellite-telecommunications networks.

24) A method utilizing one or more commercially available off-the-self (COTS) wireless peripherals to form a communication channel with a commercially available off-the-self (COTS) mobile computing device for communicating, via a commercial network, an emergency communication to a location remote from said COTS mobile computing device, wherein said COTS mobile computing device utilizes at least three program codes initiating said emergency communication, and wherein initiation of said emergency communication comprises the steps of:
a) causing said mobile computing device to retrieve a discovery list of discovered COTS wireless peripheral identifiers discovered and previously stored in a memory or retrieve a trust list of trusted COTS wireless peripherals trusted and previously stored in said memory, wherein retrieval of said discovery list and retrieval of said trust list are initiated by a first program code;
b) causing said mobile computing device to reveal said discovery list and/or reveal said trust list of wireless peripherals for allowing any revealed COTS wireless peripheral identifier to be stored in said memory, wherein storage of any said revealed COTS wireless peripheral identifier is initiated by a second program code;
c) causing said mobile computing device to:
i) discover and match at least one of said revealed COTS wireless peripheral identifiers stored in said memory; or
ii) establish a communication, via said communications channel, with at least one COTS wireless peripheral corresponding to one of said revealed COTS wireless peripheral identifiers stored in said memory; and
iii) responsive to a user's interaction with an interface of said matched and discovered wireless peripheral or establishment of said communications channel, said COTS mobile computing device, via a network communications link, communicates said emergency communication.

25) The method of claim 24 comprising the steps of providing said COTS mobile computing device with a peripheral radio resource and a wireless network radio resource.

26) The method of claim 25 comprising the step of:
a) cancelling said emergency communication; or
b) reselecting said COTS wireless peripheral and its corresponding identifier previously cancelled; or
c) selecting another said COTS wireless peripheral and its corresponding identifier to initiate said emergency communication.

27) The method of claim 26 comprising the step of including biometric, geographic location, accelerometric sensor, shock sensor, audio input, still image, video inputs and/or time data into said emergency communication.

28) The method of claim 26, wherein said location remote from said mobile computing device is one or more of the following: SMS/MMS destinations, e-mail destinations (202), Voice-over-IP destinations, public switched telephone network (PSTN) destinations, circuit-switched telephony destinations and/or public-safety answering point (P SAP) destinations.
